(19) United States
(12) Patent Application Publication
(10) Pub. No.: US 2019/0323540 A1
(43) Pub. Date: Oct. 24, 2019

(54) FASTENER FOR FASTENING A WHEEL RIM TO A WHEEL HUB

(71) Applicant: GOURMET EQUIPMENT (TAIWAN) CORPORATION, Taipei (TW)

(72) Inventor: Peter J.H. CHANG, Taipei (TW)

(21) Appl. No.: 16/027,842

(22) Filed: Jul. 5, 2018

(30) Foreign Application Priority Data
Apr. 19, 2018 (TW) 107205105

(51) Int. Cl. F16B 33/00; B60B 3/16

(52) U.S. Cl. CPC F16B 33/008; B60B 2900/572; B60B 2900/212; B60B 3/16

(57) ABSTRACT

A fastener is adapted to fasten a wheel rim to a wheel hub. The wheel rim has multiple hole-defining walls respectively defining multiple installation holes. The fastener includes a main body and a sleeve. The main body extends along a central axis thereof, is adapted to engage the wheel hub, and has an abutting portion corresponding in shape to a corresponding one of the installation holes and extending into the corresponding installation hole. The sleeve is sleeved and retained on the abutting portion, and has a contacting surface, which abuts against corresponding one of the installation holes.

### CROSS-REFERENCE TO RELATED APPLICATION

This application claims priority of Taiwanese Utility Model Patent Application No. 107205105, filed on Apr. 19, 2018.

### FIELD

The disclosure relates to a fastener, and more particularly to a fastener for fastening a wheel rim to a wheel hub.

### BACKGROUND

A wheel rim of a vehicle is fastened to a wheel hub through a plurality of fasteners. The wheel hub is typically provided with a plurality of threaded holes or threaded studs, and each of the fasteners is configured as a bolt (when the wheel hub is provided with the threaded holes) or a nut (when the wheel hub is provided with the threaded studs).

A conventional fastener has a zinc coating layer, which is a soft metal that is capable of fittingly abutting against the surface of the wheel rim to maintain effective torque retention for a prolonged period of time, thereby ensuring that the wheel rim is fixed to the wheel hub. However, the zinc exposed from the wheel rim tends to be oxidized and eroded after long-term exposure to the atmosphere. An alternative fastener is provided to have a chromium coating layer. Chromium is colorful and is visually appealing. Compared with zinc, chromium also possesses superior erosion resistance. However, the hardness of chromium may cause damage to the wheel rim when fixing the wheel rim to the wheel hub. Moreover, chromium has poor adhesive properties, which may eventually cause loosening of the fastener, resulting in detachment of the wheel rim from the wheel hub. Although other surface treatments may be applied to the fastener to improve visual appearance thereof, they may also encounter the abovementioned issues.

### SUMMARY

Therefore, an object of the disclosure is to provide a fastener that can alleviate at least one of the drawbacks of the prior art.

According to an aspect of the present disclosure, a fastener is adapted to fasten a wheel rim to a wheel hub. The wheel rim has a plurality of hole-defining walls that respectively define a plurality of installation holes.

The fastener includes a main body and a sleeve. The main body extends along a central axis thereof, and is adapted to engage the wheel hub. The main body has an abutting portion that corresponds in shape to a corresponding one of the installation holes and that extends into the corresponding one of the installation holes. The sleeve is retained on the abutting portion of the main body and has a contacting surface, which abuts against a corresponding one of the hole-defining walls defining the corresponding one of the installation holes.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary perspective view, which illustrates a first embodiment of a fastener of this disclosure adapted to fasten a wheel rim to a wheel hub;

FIG. 2 is a perspective view of the first embodiment;

FIG. 3 is a schematic partly sectional view of the first embodiment:

FIG. 4 is a perspective view of a second embodiment of the fastener according to the present disclosure;

FIG. 5 is a schematic partly sectional view of the second embodiment;

FIG. 6 is a perspective view of a third embodiment of the fastener according to the present disclosure;

FIG. 7 is a schematic partly sectional view of the third embodiment;

FIG. 8 is a perspective view of a fourth embodiment of the fastener according to the present disclosure;

FIG. 9 is a schematic partly sectional view of the fourth embodiment;

FIG. 10 is a perspective view of a fifth embodiment of the fastener according to the present disclosure;

FIG. 11 is a schematic partly sectional view of the fifth embodiment;

FIG. 12 is a perspective view of a sixth embodiment of the fastener according to the present disclosure;

FIG. 13 is a schematic partly sectional view of the sixth embodiment;

FIG. 14 is a perspective view of a seventh embodiment of the fastener according to the present disclosure;

FIG. 15 is a schematic partly sectional view of the seventh embodiment;

FIG. 16 is a perspective view of an eighth embodiment of the fastener according to the present disclosure;

FIG. 17 is a schematic partly sectional view of the eighth embodiment;

FIG. 18 is a perspective view of a ninth embodiment of the fastener according to the present disclosure;

FIG. 19 is a schematic partly sectional view of the ninth embodiment;

FIG. 20 is a perspective view of a tenth embodiment of the fastener according to the present disclosure; and

FIG. 21 is a schematic partly sectional view of the tenth embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

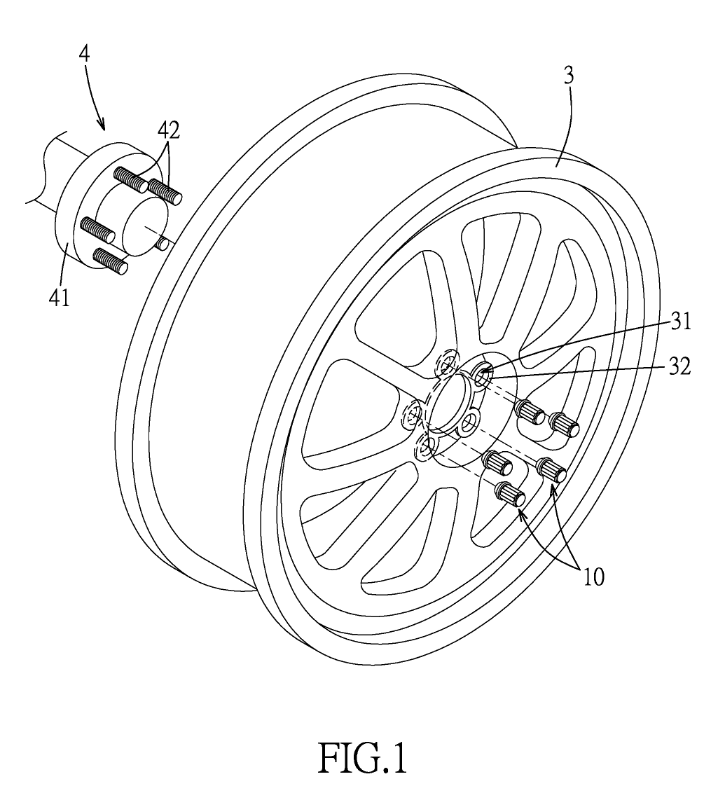

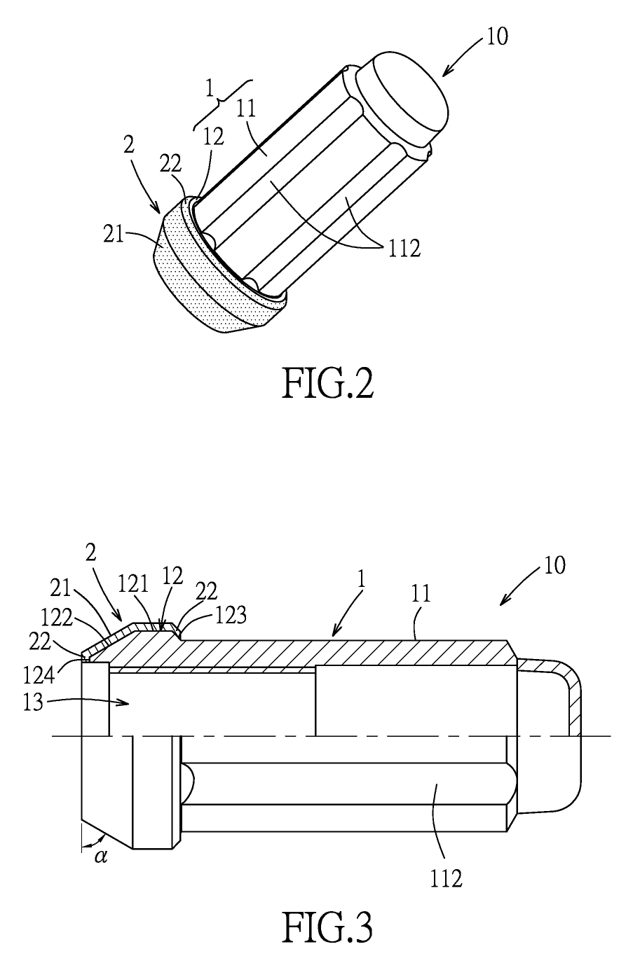

Referring to FIGS. 1 to 3, a first embodiment of a fastener 10 according to the present disclosure is adapted to fasten a wheel rim 3 to a wheel hub 4. In this embodiment, the wheel rim 3 is fastened to the wheel hub 4 by a plurality of the fasteners 10 (see FIG. 1). The wheel rim 3 has a plurality of annular hole-defining walls 32 that respectively define a plurality of circular installation holes 31. The wheel hub 4 includes a hub body 41 and a plurality of threadedly engaging sections 42 extending from the hub body 41. In assembly, one side of the wheel rim 3 is moved close to the wheel hub 4, and each of the threadedly engaging sections 42 of the wheel hub 4 extends into a respective one of the installation holes 31. Afterwards, the fasteners 10 respectively extend into the installation holes 31 from the other side of the wheel rim 3 to respectively engage the threadedly engaging sections 42 of the wheel hub 4 so as to fasten the wheel rim 3 to the wheel hub 4.

Only one of the fasteners 10, one of the installation holes 31, one of the hole-defining walls 32 and one of the threadedly engaging sections 42 of the wheel hub 4 are described below for the sake of brevity.

In this embodiment, the fastener 10 includes a main body 1 and a sleeve 2. The main body 1 is column shaped, extends along a central axis (L) thereof. The main body 1 of the fastener 10 is adapted to threadedly engage the threadedly engaging section 42 of the wheel hub 4. The main body 1 has an abutting portion 12 that corresponds in shape to the installation hole 31, and that extends into the installation hole 31. The main body 1 further has an extending portion 11 that extends from the abutting portion 12 along the central axis (L) in a direction away from the wheel hub 4.

The sleeve 2 is sleeved and retained on the abutting portion 12 of the main body 1, and has a contacting surface 21, which abuts against the hole-defining wall 32 defining the installation hole 31. Specifically, the abutting portion 12 has a first end 123 proximate to the extending portion 11, a second end 124 opposite to the first end 123 and distal from the extending portion 11, a uniform-diameter third section 121 that extends from the first end 123 toward the second end 124 and that has an outer diameter larger than an outer diameter of the extending portion 11 of the main body 1, and a varied-diameter fourth section 122 that extends from the third section 121 to the second end 124, that has an outer diameter gradually reducing in a direction away from the third section 121 and toward the second end 124, and that presses the sleeve 2 against the hole-defining wall 32. In this embodiment, the fourth section 122 is frusto-conical, and has an outer surface inclined relative to and extending from the third section 121 in a direction toward the second end 124. The sleeve 2 corresponds in shape to the abutting portion 12 of the main body 1, and has two flange portions 22 that respectively abut against the first and second ends 123, 124 of the abutting portion 12 such that the sleeve 2 is positioned on the abutting portion 12. It is worth mentioning that, by changing the distance between the flange portions 22, the sleeve 2 can be controlled to be fixed to the abutting portion 12 or to be rotatable relative to the abutting portion 12. Specifically, when the flange portions 22 tightly and respectively abut against the first and second ends 123, 124 of the abutting portion 12, the sleeve 2 is fixed to the abutting portion 12 and is not rotatable relative to the abutting portion 12. When the flange portions 22 respectively abut against the first and second ends 123, 124 of the abutting portion 12 in a relatively loose manner, the sleeve 2 is rotatable relative to the abutting portion 12. In this case, when the fastener 10 is operated to engage the threadedly engaging section 42 of the wheel hub 4, the sleeve 2 is pressed against the hole-defining wall 32 and only the main body 1 of the fastener 10 is rotatable relative to the hole-defining wall 32, thereby preventing the sleeve 2 from scratching the hole-defining wall 32.

Since the main body 1 and the sleeve 2 are separately manufactured and then assembled together, surface treatment can be separately applied to the main body 1 and the sleeve 2. In this embodiment, the main body 1 may be coated with chromium, and the sleeve 2 may be coated with zinc. When the fastener 10 is engaged with the threadedly engaging section 42 of the wheel hub 4, the zinc-coated sleeve 2 can tightly abut against the hole-defining wall 32, so as to prevent relative rotation between the wheel rim 3 and the fastener 10, thereby reducing the risk of detachment of the wheel rim 3 from the wheel hub 4. Moreover, a portion of the chromium-coated main body 1 of the fastener 10 exposed from the wheel rim 3 is more corrosion resistant and more aesthetically appearing. In practical use, the main body 1 may be coated with other metals, and each of the main body 1 and the sleeve 2 may be made of different metals according to practical requirements.

In this embodiment, the threadedly engaging section 42 of the wheel hub 4 is configured as a threaded stud, and the main body 1 is configured as a nut and has a threaded hole 13 adapted for threaded engagement with the threadedly engaging section 42 of the wheel hub 4. The threaded hole 13 has an opening adjacent to the second end 124 of the abutting portion 12, and extends from the abutting portion 12 to the extending portion 11. The inclination degree of the outer surface of the fourth section 122 may be changed according to practical requirements. In this embodiment, an included angle a between the outer surface of the fourth section 122 and an end surface of the second end 124 is 60 degrees. An outer surrounding surface of the extending portion 11 of the main body 1 may be configured to facilitate operation of a user. In this embodiment, a plurality of spline grooves 112 are formed in the outer surrounding surface of the extending portion 11 of the main body 1 and extend along the central axis (L).

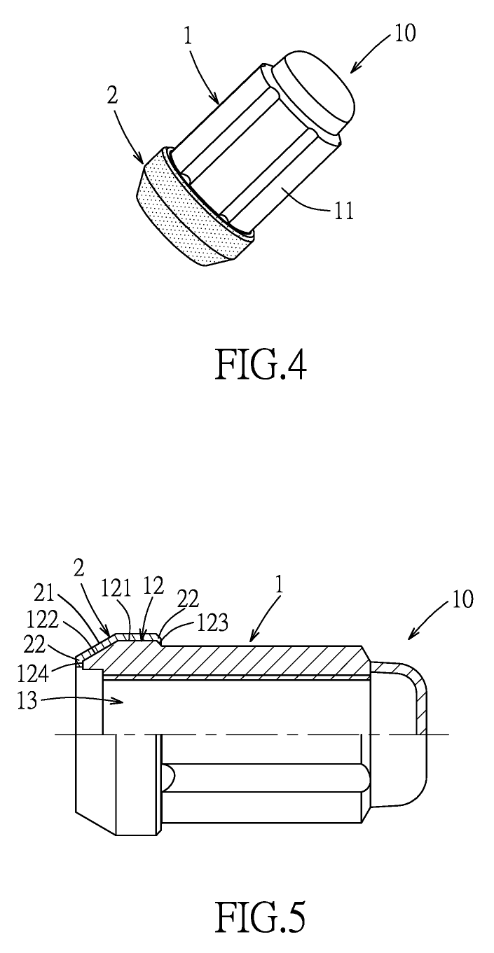

FIGS. 4 and 5 show a second embodiment of the fastener 10 according to the present disclosure. The second embodiment has a dimension slightly smaller than that of the first embodiment.

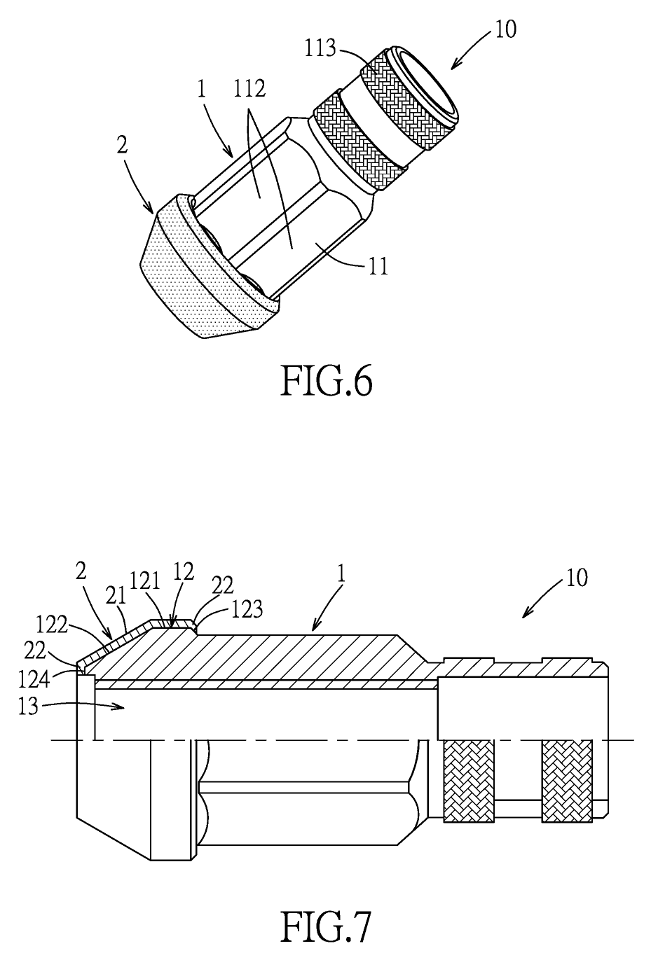

FIGS. 6 and 7 show a third embodiment of the fastener 10 according to the present disclosure that has a structure modified from that of the first embodiment. In the third embodiment, the extending portion 11 is provided with a knurled gripping section 113 that is opposite to the abutting portion 12 and that facilitates operation by the user.

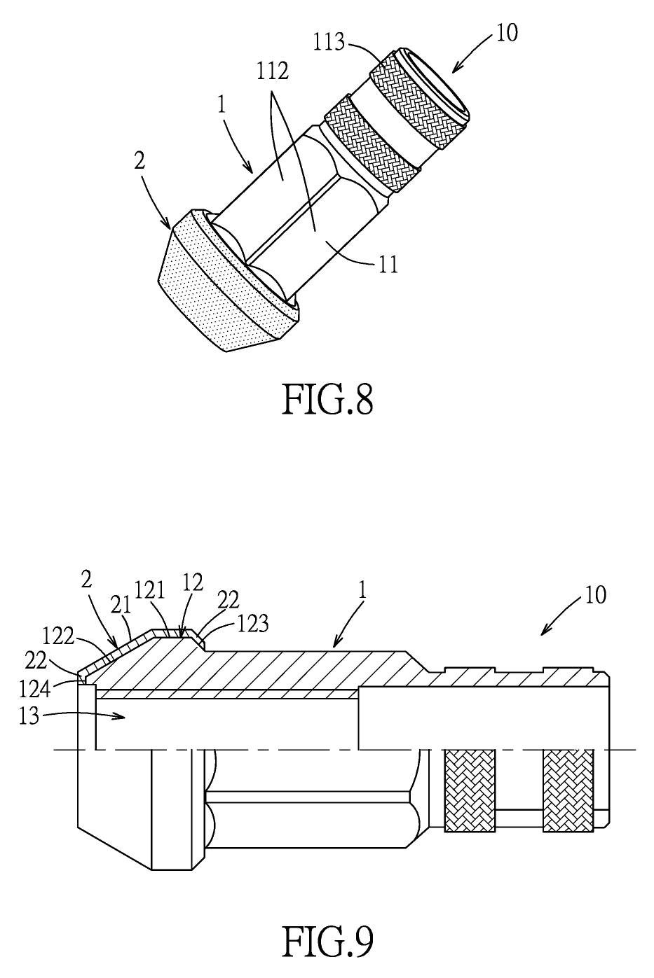

FIGS. 8 and 9 show a fourth embodiment of the fastener 10 according to the present disclosure that has a structure modified from that of the third embodiment. In the fourth embodiment, the hex portion is smaller than that of the third embodiment.

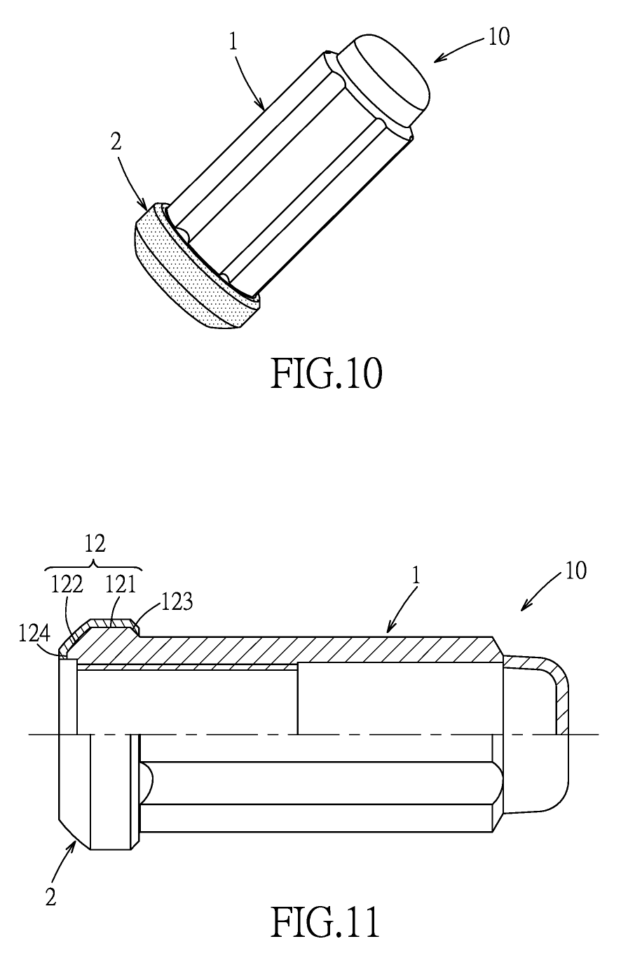

FIGS. 10 and 11 show a fifth embodiment of the fastener 10 according to the present disclosure that has a structure modified from that of the first embodiment. In the fifth embodiment, the fourth section 122 has an arc outer surface that is connected between the second end 124 and the third section 121. It is worth mentioning that a curvature radius of the arc outer surface may be, such as 12 mm, 13 mm or 14 mm, and may be changed according to practical requirements.

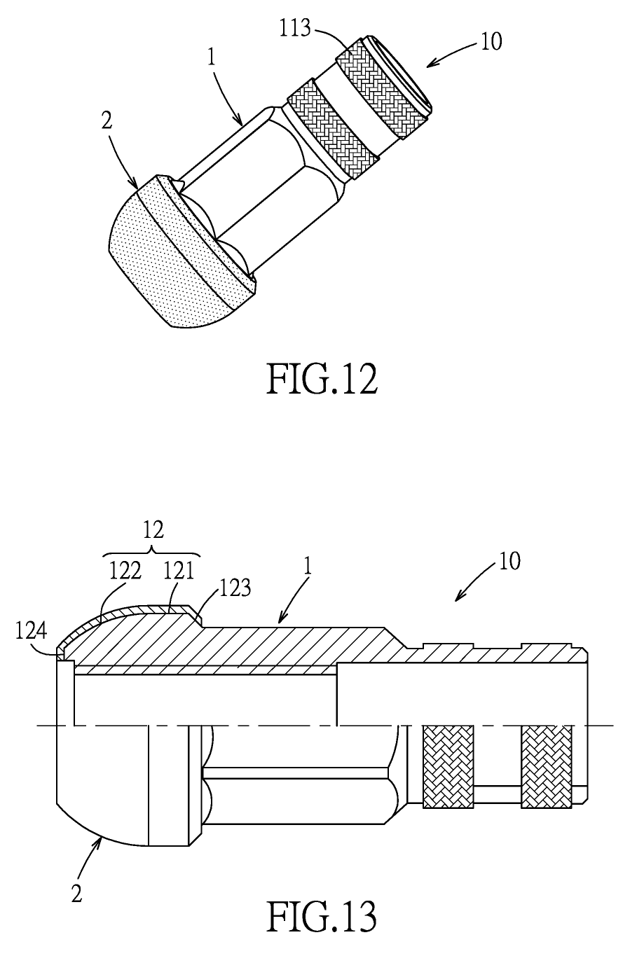

FIGS. 12 and 13 show a sixth embodiment of the fastener 10 according to the present disclosure that has a structure modified from that of the third embodiment. In the sixth embodiment, the fourth section 122 has the arc outer surface that is connected between the second end 124 and the third section 121. Curvature radius of the arc outer surface may be changed according to practical requirements.

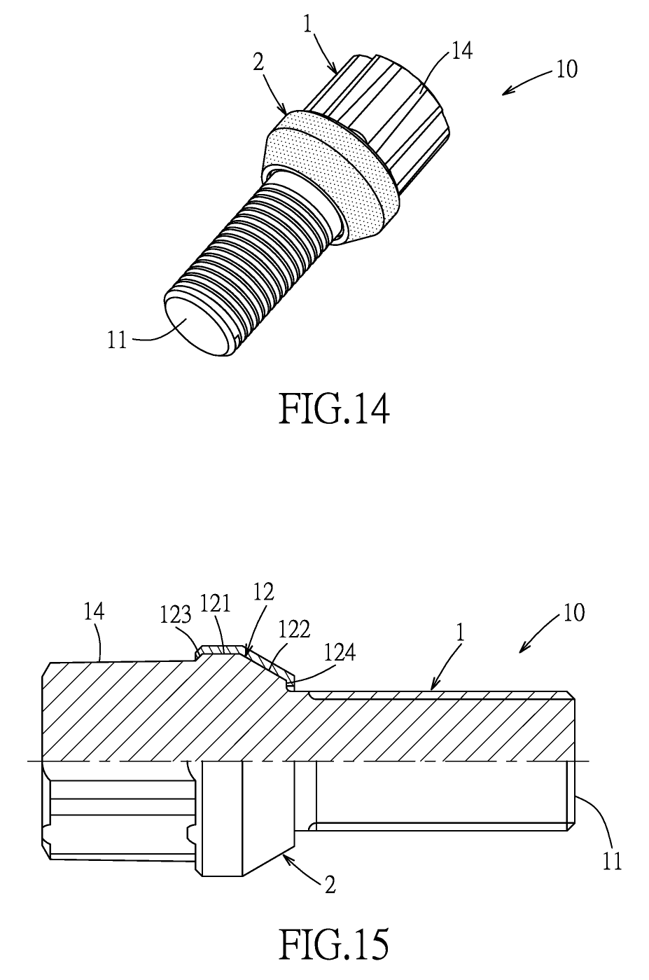

Referring to FIGS. 14 and 15, in a seventh embodiment of the fastener 10, the main body 1 of the fastener 10 is configured as a bolt, in which the extending portion 11 of the main body 1 is configured as external thread. The main body 1 further has a head portion 14 that is connected to the abutting portion 12 such that the abutting portion 12 is located between the extending portion 11 and the head portion 14. In this embodiment, the threadedly engaging section 42 of the wheel hub 4 is configured as a threaded hole (not shown) for threaded engagement with the extending portion 11 of the fastener 10.

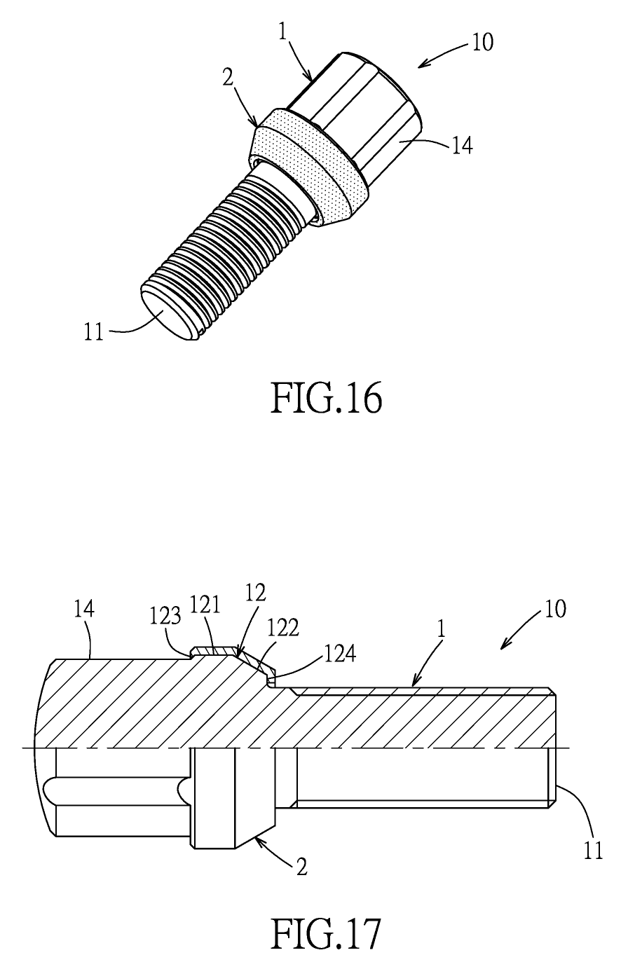

FIGS. 16 and 17 show an eighth embodiment of the fastener 10 according to the present disclosure that has a structure modified from that of the seventh embodiment. In the eighth embodiment, the head portion 14 has fewer grooves than that of the seventh embodiment.

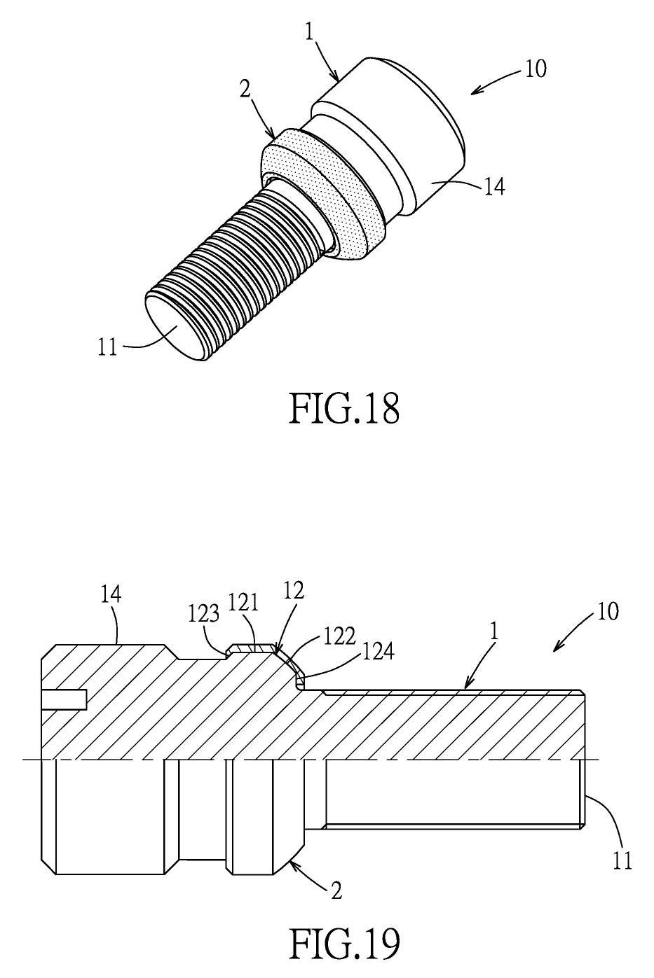

FIGS. 18 and 19 show a ninth embodiment of the fastener 10 according to the present disclosure that has a structure modified from that of the seventh embodiment. In the ninth embodiment, the head portion 14 has a structure different from that of the seventh embodiment, and the fourth section 122 has the arc outer surface that is connected between the second end 124 and the third section 121. Curvature radius of the arc outer surface may be changed according to practical requirements.

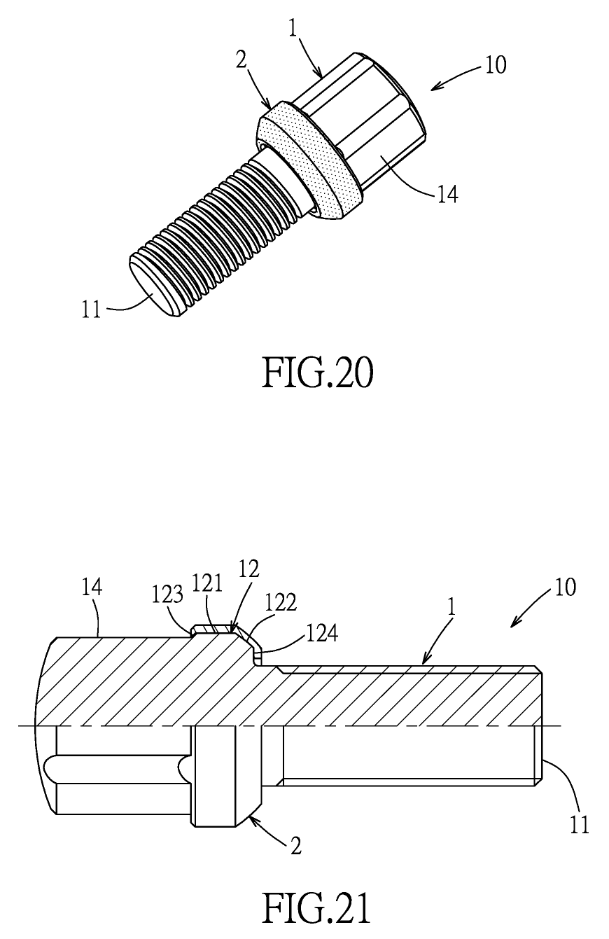

FIGS. 20 and 21 show a tenth embodiment of the fastener 10 according to the present disclosure that has a structure modified from that of the seventh embodiment. In the tenth embodiment, the head portion 14 has a structure different from that of the seventh embodiment, and the fourth section 122 has the arc outer surface that is connected between the second end 124 and the third section 121. Curvature radius of the arc outer surface may be changed according to practical requirements.

It is worth mentioning that the dimension and structure of the fastener 10 may be adjusted according to practical requirements, and may be designed for a specific hand tool to be theftproof.

To sum up, the main body 1 and the sleeve 2 of the fastener 10 according to the present disclosure can be separately processed by different surface treatments to fulfill both aesthetical appearance and safety.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic maybe included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiment and variation but is intended to cover various arrangements included within the spirit and scope of the broadest interpretation so as to encompass all such modifications and equivalent arrangements.

What is claimed is:

1. A fastener adapted to fasten a wheel rim to a wheel hub, the wheel rim having a plurality of hole-defining walls that respectively define a plurality of installation holes, said fastener comprising:
a main body that extends along a central axis thereof, and is adapted to engage the wheel hub, said main body having an abutting portion that corresponds in shape to a corresponding one of the installation holes and that extends into the corresponding one of the installation holes; and
a sleeve that is retained on said abutting portion of said main body and that has a contacting surface, which abuts against a corresponding one of the hole-defining walls defining the corresponding one of the installation holes.

2. The fastener as claimed in claim 1, wherein said sleeve is coated with zinc.

3. The fastener as claimed in claim 2, wherein said main body is coated with chromium.

4. The fastener as claimed in claim 1, wherein said main body further has an extending portion that extends from said abutting portion along the central axis.

5. The fastener as claimed in claim 4, wherein:
said abutting portion has a first end, a second end opposite to said first end, a third section that extends from said first end toward said second end and that has an outer diameter larger than an outer diameter of said extending portion of said main body, and a fourth section that extends from said third section to said second end and that presses said sleeve against the corresponding one of the hole-defining walls; and
said sleeve corresponds in shape to said abutting portion of said main body and has two flange portions that respectively abut against said first and second ends of said abutting portion such that said sleeve is positioned on said abutting portion.

6. The fastener as claimed in claim 5, wherein said fourth section is frusto-conical.

7. The fastener as claimed in claim 6, wherein said fourth section has an outer surface inclined from said third section toward said second end.

8. The fastener as claimed in claim 5, wherein said fourth section has an arc outer surface connected between said second end and third section.

9. The fastener as claimed in claim 5, wherein said main body is a nut and has a threaded hole that is adapted for threaded engagement with the wheel hub, said threaded hole having an opening adjacent to said second end of said abutting portion.

10. The fastener as claimed in claim 5, wherein said main body is a bolt, said extending portion of said main body being externally threaded, said main body further having a head portion that is connected to said abutting portion such that said abutting portion is located between said extending portion and said head portion.

11. The fastener as claimed in claim 1, wherein said sleeve is rotatable relative to said abutting portion.
